(19) United States
(12) Patent Application Publication
(10) Pub. No.: US 2002/0059450 A1
(43) Pub. Date: May 16, 2002

(54) Data output system and data outputting method

(76) Inventor: Kazunori Masaki, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/917,741

(22) Filed: Jul. 31, 2001

(30) Foreign Application Priority Data
Aug. 1, 2000 (JP) 233231/2000

(51) Int. Cl. G06F 15/16

(52) U.S. Cl. 709/238

(57) ABSTRACT

The present invention provides a data output system which can transmit data from the nearest server within a short time at a point of time whereat a user has been driven by the necessity of outputting the data. For this purpose, in this system, the user's location is pursued, and the data is moved to an information accumulating apparatus corresponding to location information indicative of the user's location, and in accordance with the instructions from the user for the outputting of the data, the relevant data is transmitted from an information accumulating apparatus storing the relevant data therein to an output apparatus.

### BACKGROUND OF THE INVENTION

1. Field of the Invention

This invention relates to a data output system in which a plurality of output apparatuses and computers are connected together through a network, an output controlling method, a mobile information terminal, an information processing apparatus, an information accumulating apparatus and a storage medium.

2. Related Background Art

Heretofore, in a data output system in which at least one output apparatus and an information processing apparatus such as a personal computer are connected to a network, a user has controlled the output apparatus such as a digital copier on the network from the personal computer connected to the network, and has effected print output.

In this case, the user has prepared document data to be printed by a client's personal computer, and thereafter the personal computer has executed a printer driver and has converted the document data into PDL type print data, and has transmitted the PDL type print data to the digital copier via the network.

### SUMMARY OF THE INVENTION

The above-described data output system according to the prior art, however, has suffered from the following problems.

When he wants to effect an output by the use of an output apparatus at his destination of outing, the user has once preserved output data in a portable recording medium such as a floppy disk (FD) or a magneto-optical disc (MO), and thereafter has taken the recording medium with him to the destination of outing.

Then, at the destination of outing, the user has inserted the recording medium into a personal computer connected to the network, and has transmitted data from the personal computer to the output apparatus. According, much time and labor have been required until the user gets a print. Also, when the data size of the data is large, it has been impossible to store the data in the recording medium.

So, the user requests somebody to transmit the data to the output apparatus at the destination of outing when the data has become necessary, whereby the recording medium can be made unnecessary. However, when the data has suddenly become necessary, if the user has had the data transmitted to the destination of outing at that time, wrong transmission has been caused by the data transmission from the remote place or much transmission time has been required, and this has not been efficient.

So, the present invention has as its object to provide a data output system which can output data from the nearest server within a short time at a point of time whereat the data has become necessary to the user.

### BRIEF DESCRIPTION OF THE DRAWINGS

FIG. 1 shows the system construction of a network printing environment.

FIG. 2 shows the epitome of output processing.

FIG. 3 shows a location information collecting system by a location information management server.

FIG. 4 is a flow chart showing the processing procedure of designating document information.

FIG. 5 is a flow chart showing the processing procedure of storing the document information.

FIG. 6 is a flow chart showing the processing procedure of determining the movement of output document data.

### DESCRIPTION OF THE PREFERRED EMBODIMENTS

An embodiment of the data output system, the output controlling method, the mobile information terminal, the information processing apparatus, the information accumulating apparatus and the storage medium of the present invention will hereinafter be described with reference to the drawings. The data output system according to the present embodiment is applied to the system of a network printing environment.

[System Construction]

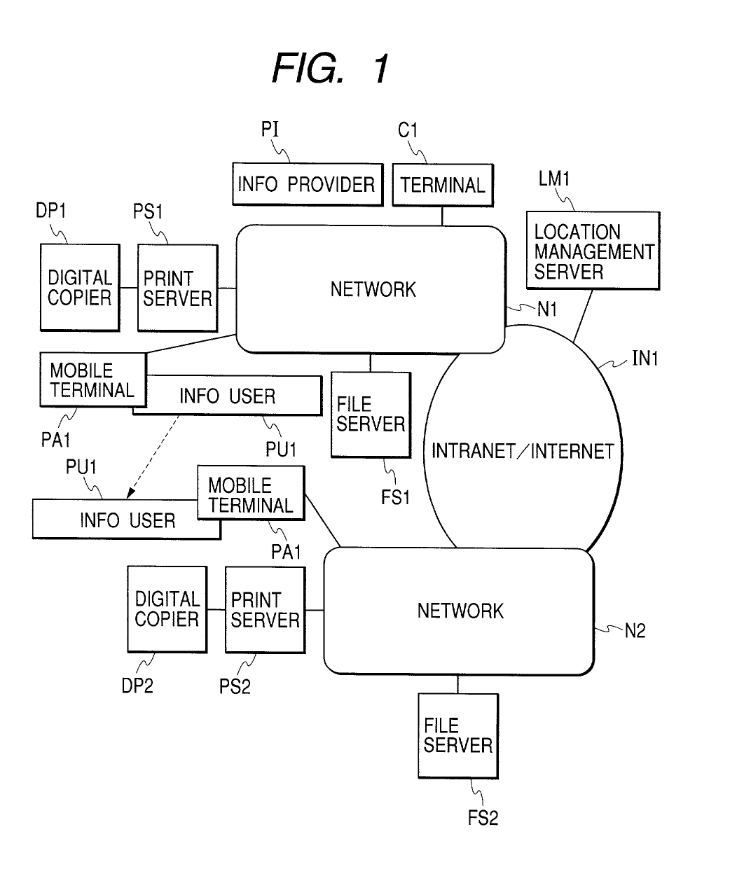

FIG. 1 shows the system construction of a network printing environment. An information processing apparatus (terminal) C1 used by a document information provider PI is connected to a print server Ps1 and a file server Fs1 through a network N1. A digital copier Dp1 is connected to the print server Ps1.

Here, the document information provider is a person having the role of providing the information of output documents he possesses to other users. Also, a user having the role of receiving the information transmitted by the document information provider is expressed as a document information user. That is, each client on the network is a document information provider and also a document information user.

The network N1 is connected to a network N2 existing in an area discrete from the network N1 via Intrenet In1. Intranet may be replaced by Internet.

A print server Ps2 and a file server Fs2 are connected to the network N2. A digital copier Dp2 is connected to the print server Ps2. A mobile terminal Pa1 carried by the information user Pa1 with him is connected to the networks N1 and N2. This mobile terminal Pa1 is a mobile information terminal having the communicating function, and has the function of being capable of being carried to a destination of movement by the information user Pa1 and being connected to a file server existing in the network at the destination of movement. Also, a location information management server Lm1 is connected to Intranet In1.

While in FIG. 1, the client of the network N1 is only the terminal C1 used by the document information users, the number thereof is not particularly limited. Also, while in FIG. 1, the print server Ps1 and the digital copier Dp1, and the print server Ps2 and the digital copier Dp2 are discrete apparatuses, respectively, use may be made of digital copiers of a type incorporating a print server therein.

[Output Control]

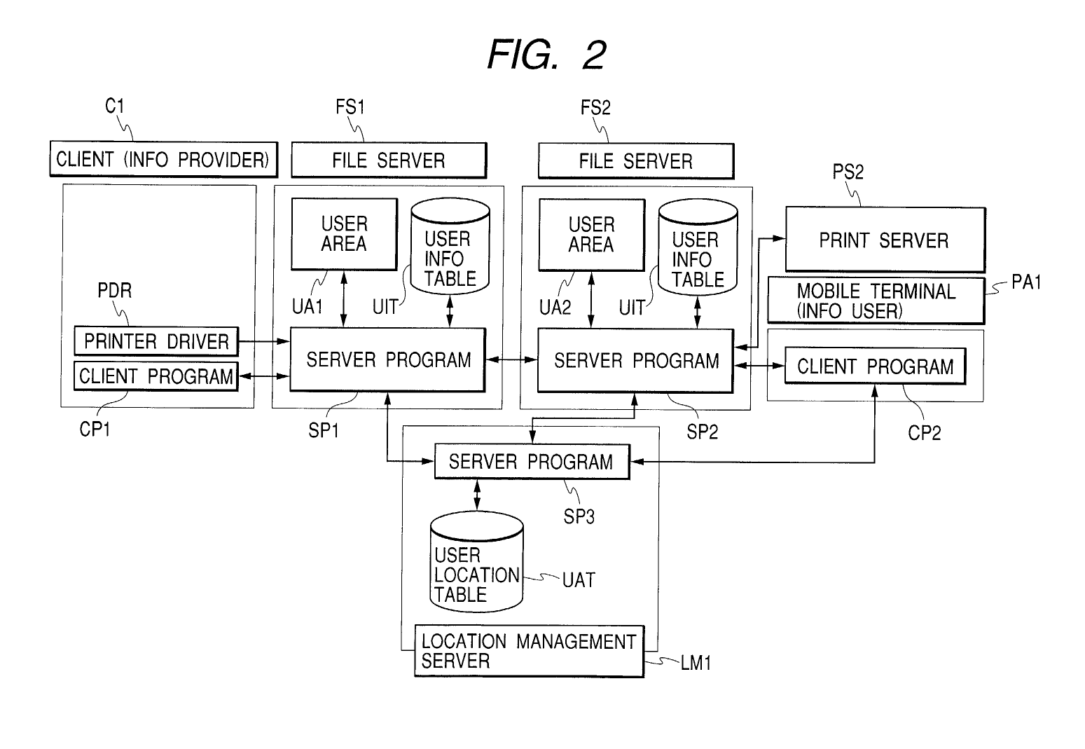

FIG. 2 shows the epitome of the output controlling process. In FIG. 2, there are shown the relations among the network client (terminal) C1 having the role as the information provider, the file server Fs1 connected to the same network N1 as the network client C1, the file server Fs2 connected to the network N2 discrete from the network client C1, the print server Ps2 connected to the same network N2 as the file server Fs2, the mobile terminal Pa1 connected to the same network N2 as the file server Fs2, and the location information management server Lm1 existing on Intranet or Internet In1.

The location information management server Lm1 is characterized in that it catches the information user's acting area and reports it to an automatic transmission program for managing respective document data by a server program in each file server.

In the network client C1 as a terminal used by the information provider, a document obtained by the information provider or prepared by any application is produced into a PDL code suited for the image processing portion of the digital copier by a printer driver Pdr.

The produced PDL code is delivered to the server program Sp1 of the file server Fs1. At this time, the information about the information user designated by the client program Cp1 of the client C1 is also reported to the server program Sp1. The server program Sp1 incorporates the document data (PDL code) into the automatic transmission program, and thereafter stores it in a user document storing area Ua1.

A user information table UiT exists in the file server Fs1, and stores the information of each registered user (information user) therein. The location information management server Lm1 collects each information user's acting area information by a server program Sp3.

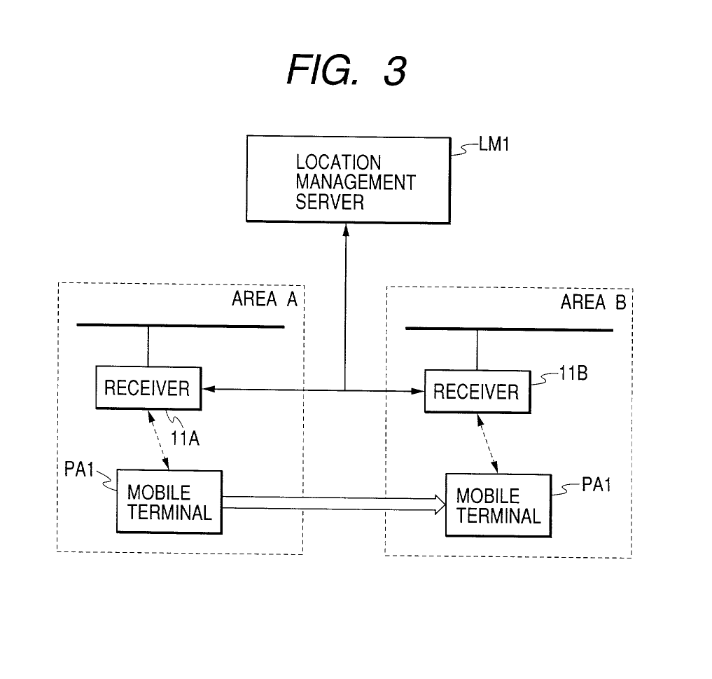

FIG. 3 shows a location information collecting system by the location information management server Lm1. In the location information collecting system, the existing communication service can be utilized till the collection of information. That is, if there is an information user in an area A or an area B, receives 11A and 11B in the respective areas effect communication with the mobile terminal Pa1 carried by the information user with him, and specify the location of the mobile terminal Pa1.

In FIG. 2, there is shown a case where the information user has moved to near an area in which the file server Fs2 exists. when like this, the location information of the information user has changed, the file server nearest to the current location of the information user is calculated. In FIG. 2, the file server Fs2 is chosen, and the location information management server Lm1 reports new location information to the server program Sp1 of the file server Fs1 in which the user document has been stored before the change of the location information. The server program Sp1 starts the automatic transmission program stored in the user document storing area Ua1, and reports the information of the file server at the destination of movement.

The started automatic transmission program moves to the file server Fs2 with the document data. The automatic transmission program effects the transmission output report to the server program Sp2 of the file server Fs2, thus terminating the automatic transmission program.

The server program Sp2 of the file server Fs2 stores this document data in a user document storing area Ua2. The information user instructs the server program Sp2 of the file server Fs2 by the client program Cp2 of the mobile information terminal Pa1 to execute outputting. The server program Sp2 of the file server Fs2 takes out the output executing document from the user document storing area Ua2, and thereafter transmits the output document to the print server Ps2. The print server Ps2 outputs this output data to an output apparatus it manages (herein, the digital copier Dp2).

[Designation of the Document Information User]

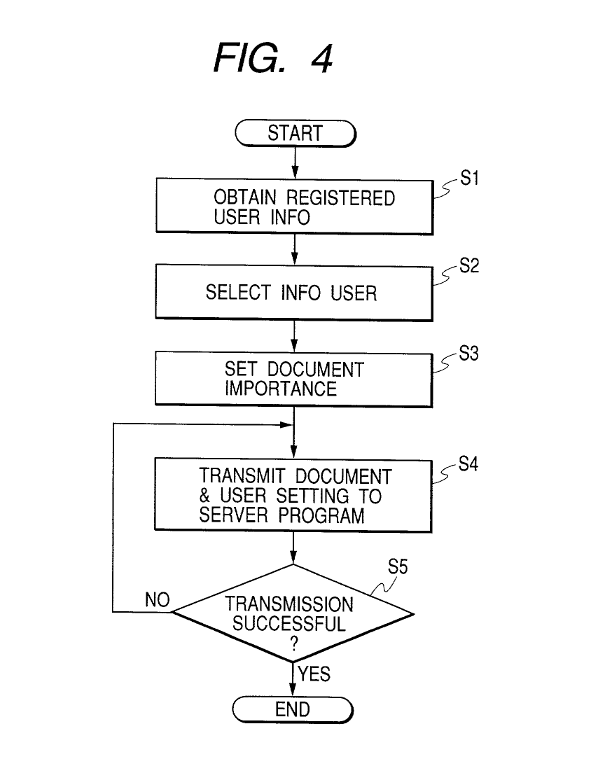

FIG. 4 is a flow chart showing the processing procedure of designating the user of document information. This processing is carried out by the cooperation between the client program Cp1 shown in FIG. 2 and the server program Sp1 always stationed at the file server Fs1.

First, the client program Cp1 obtains the list of registered user information from the server program Sp1 (step S1). Here, the registered user is a user registered in advance in the user information table of each file server as the user of the output controlling system. At this step S1, the server program Sp1 reads the user information table UiT of FIG. 2 and reports it to the client program Cp1.

The document information provider selects an information user from the list of document information users displayed on the information display screen of the network client C1 by the client program Cp1 (step S2). At this time, the selected document information user may be the document information provider himself.

The information of the degree of importance or urgency or the like of the document data to be transmitted is set (step S3). The content of this setting is utilized to determine the order of priority relative to the existing output document data at the destination of transmission as when the storing area of the destination of transmission is deficient during the automatic transmission of the output document data. Besides the degree of importance or urgency, a document title, the epitome of the content of the document, etc. necessary for the information user to confirm the content of the output document may be set.

The document data (PDL code) and the previously set user setting information are transmitted to the server program Sp1 (step S4). Then, whether the transmission has been successful is discriminated (step S5). If the transmission has been successful, the processing is terminated. On the other hand, if the transmission has not been successful, return is made to the processing of the step S4.

[Storing of the Document Information]

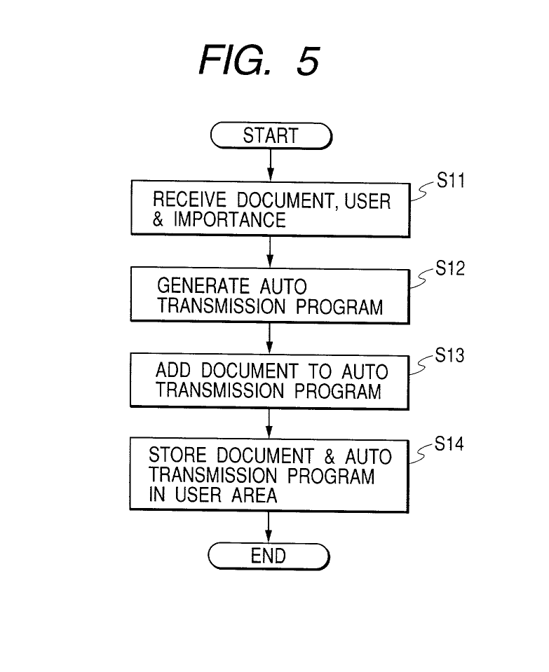

FIG. 5 is a flow chart showing the processing procedure of storing the document information. This processing is processed by the server program Sp1 always stationed in the file server Fs1. First, the server program Sp1 receives output document data and the transmission setting of the information user and importance from the client program Cp1 (step S11).

An automatic transmission program for managing the received output document data is generated (step S12). The output document data is related (added) to and managed by the generated automatic transmission program (step S13). This automatic transmission program is a program having the function of transmitting its own copy including the managed output document data to the destination of movement. Also, this automatic transmission program is also an agent program starting a transmitting method from the server program to thereby recognize the next destination of movement and move to the destination of transmission. The life cycle of the automatic transmission program is controlled by the server program always stationed in each file server.

The objects of the automatic transmission program and output document data related at the step S13 are stored in the user document storing area Ua1 (see FIG. 2) (step S14), thus terminating the processing.

[Pursuit of the Document Informater User]

This processing is processed by the cooperation between the server program Sp2 always stationed in the location information management server Lm1 and the mobile terminal Pa1 carried by the information user with him. The location information management is shown by the use of two areas, i.e., the area A and the area B of FIG. 3.

The receivers 11A and 11B are installed in the areas A and B, respectively. The information user carrying the mobile information terminal Pa1 with the communication function with him moves in each area. The receivers 11A and 11B receive a signal produced during the ON of the power source of the mobile information terminal Pa1.

The location information of the information user managed by the location information management server Lm1 is collected from the receivers 11A and 11B in the respective areas into the location information management server Lm1. The location information management server Lm1 records each user's location on a management table at predetermined time intervals. When the information user moves from the area A to the area B, the location of the mobile information terminal Pa1 is caught by the receiver 11B in the area B, and the updating of the management table is done by the location information management server Lm1.

[Movement of the Output Document Data Between the Output Information Accumulating Apparatuses]

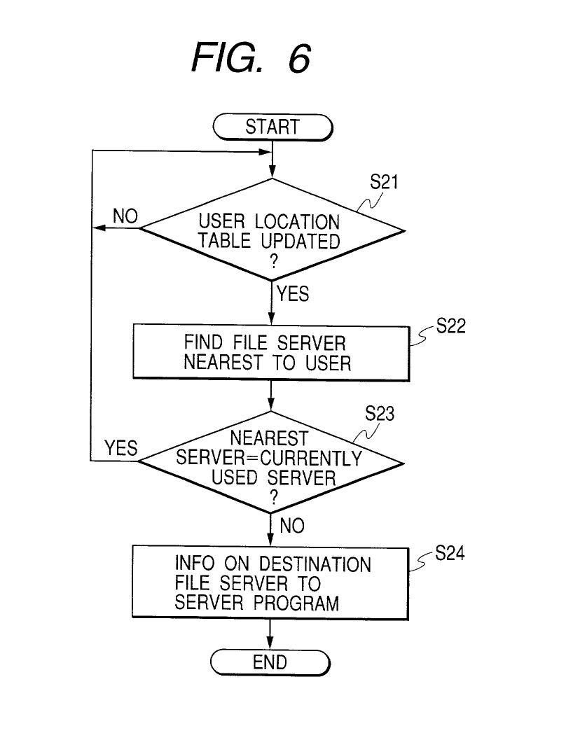

FIG. 6 is a flow chart showing the processing procedure of determining the movement of the output document data. Here, the processing of determining the movement of the output document data is the processing of determining whether the file server for managing the output document data changes by the movement of the information user.

This processing is processed by the cooperation between the server program Sp3 always stationed in the location information management server Lm1 and the server program always stationed in each output information accumulating apparatus (hereinafter referred to as the fie server).

First, the server program Sp3 discriminates whether the user location information table UaT (see FIG. 2) has been updated (step S21). This check-up of updating is done at each predetermined time. The time interval of this check-up of updating is changeable by the setting of the server program Sp3. By this setting, a load the automatic transmission of the document data applies to the network is adjusted. When the user location information table UaT is not updated, the processing of the step S21 is repeated.

On the other hand, if at the step S21, the user location information table UaT has been updated, the file server existing at the location nearest to the information user's acting area is found by the server program Sp3 (step S22). In the case of FIG. 2, the information user has moved from the file server Fs1 to the area in which the file server Fs2 is installed, and as the result of the finding at the step S22, it is determined that the file server Fs2 is the nearest file server.

Whether the nearest server is the same as the file server currently used is discriminated (step S23). If as the result of the discrimination, it is the same as the server currently used, return is made to the processing of the step S21. On the other hand, if the nearest server differs from the server currently used, the processing of a step S24 is executed.

The recognition of the currently used file server is done by the server program Sp3, and information on the information user having changed his acting area is reported to all file servers. Each file server having received the report checks up by the server program always stationed therein whether the document data of the pertinent person is held, and if this document data is held, it returns response to the server program Sp3.

Then, the information on the file server at the destination of movement found by the server program Sp3 is reported to the server program of the file server in which the information user's data is currently preserved (step S24). In the case of FIG. 2, the information on the file server Fs2 at the destination of movement is reported to the file server Fs1. Here, the server program Sp1 of the file server Fs1 inquires of the server program Sp2 of the file server Fs2 at the destination of movement about whether there is a margin in the user document storing area Ua2.

If the storing area of the file server at the destination of movement is deficient, automatic transmission is discontinued. Also, the negotiation about the order of priority is effected by the information of the degree of importance and urgency set at the step S3 of FIG. 4, and if the exchange of the output document data is possible, the exchange of the document data may be done between the file servers.

On the other hand, if there is a margin in the storing area of the file server at the destination of movement, an automatic transmission program (agent program) incorporated in the said document data is started. Further, the server program Sp1 calls an automatic transmitting method to thereby start the movement of the document data to the file server Fs2 at the destination of movement.

About the document data of which the automatic transmission has been completed, the completion of the transmission is reported to the server program Sp1 of the file server Fs1 and the server program Sp2 of the file server Fs2, and the automatic transmission program is terminated. The server program Sp2 of the file server Fs2 preserves the transmitted document data in the user document storing area Ua2 and thus, the movement between the file servers is ended.

[Perusal of the Document]

This processing is processed by the cooperation between the client program Cp2 started by the mobile terminal Pa1 of FIG. 2 and the server program always stationed in each file server.

The document user connects the mobile information terminal Pa1 carried with him to the network in which the output apparatus at the destination of movement is installed. The client program Cp2 of the mobile information terminal Pa1 inquires of the server program always stationed in each file server about the presence or absence of document data addressed to itself, and displays the result of the inquiry on an information display portion such as the liquid crystal screen of the mobile information terminal. This displayed information includes, besides the degree of importance designated at the step S3 of FIG. 4, the document title and the epitome of the document content necessary for the information user to confirm the content of the output document. As required, the information user can also peruse the output document data by the mobile information terminal Pa1.

[Printing of the Document]

This processing is processed by the cooperation between the client program Cp2 started by the mobile terminal Pa1 of FIG. 2 and the server program always stationed in the file server preserving therein the document data addressed to the information user.

In the case of FIG. 2, the client program Cp2 of the mobile terminal Pa1 reports to the server program Sp2 of the file server Fs2 the document desired to be printed, the number of prints and the information about whether the output document data should be deleted after printing. The server program Sp2 having received the report starts the automatic transmission program managing the pertinent output document data, and calls an outputting method and designates the print server Ps2. The automatic transmission program transmits the output document data to the designated print server Ps2, and when it terminates the transmission, the automatic transmission program is terminated. The print server Ps2 makes the copier effect printing on the basis of the received output document data.

Here, when the output document data is to be deleted, the pertinent document data and the automatic transmission program are deleted by the server program Sp2. The print server Ps2 having received the output data outputs it to an output apparatus (herein the digital copier Dp2) it manages.

According to what has been described above, output data incorporating therein the automatic transmission program pursuing after the information user's location information during the outputting of the document information is generated, whereby the document data exists in the nearest server at a point of time whereat the information user has been pressed for the necessity of document outputting, and the transmission time for the document data scheduled to be outputted can be shortened. Accordingly, the information user can cause the document data to be outputted from the nearest server within a short time at the point of time whereat he has been pressed for the necessity of document outputting.

The application of such system to network coping type printing services which will be evolved in convenience stores or the like in the future is studied. File servers are installed in each store, and user document storing areas are allotted to contract users.

Each user designates himself or other user and transmits output data from the PC in his or other user's home to the server of a portal site introducing the print shop of each convenience store. The output document data transmitted and registered to a particular user is transmitted to a file server at a destination to which the user moves and therefore, in a convenience store in which he has freely dropped, he can make access to a file server in the store by the use of the mobile information terminal to thereby effect quick document output.

While the foregoing is the description of the embodiments of the present invention, the present invention is not restricted to the constructions of these embodiments, but is applicable to any construction which can achieve the functions shown in the appended claims or the functions the embodiments have.

For example, while in the above-described embodiments, a case where the data is document information has been shown, the data is not limited to documents, but may be such data as images or tables. Also, while in the above-described embodiments, a case where document data is printed and outputted has been shown, the present invention is also applicable to a case where the data is outputted intactly as digital data. In this case, it becomes possible for the information user to download the digital data on a recording medium to thereby utilize it.

Also, of course, the present invention can be applied to a case where a storage medium storing therein the program code of software for realizing the function of the aforedescribed embodiments is achieved by supplying a program to the system or the apparatus. In this case, the program code itself read out from the storage medium realizes the novel function of the present invention, and the storage medium storing the program therein constitutes the present invention. In the above-described embodiments, the processing shown in the flow charts of FIGS. 4, 5 and 6 is carried out by the client programs Cp1, Cp2 and the server programs Sp1, Sp2, Sp3, as previously described, and the codes of these programs are stored in the storage medium. As the storage medium for supplying the program codes, use can be made, for example, a ROM, a floppy disc, a hard disc, an optical disc, a magneto-optical disc, a CD-ROM, a CD-R, a DVD, a magnetic tape, a nonvolatile memory card or the like.

According to the present invention, at a point of time whereat the information user has come to need data, the data exists in the nearest information accumulating apparatus. Accordingly, the transmission time of the data can be shortened, and at a point of time whereat the data has become necessary, the data can be obtained from the nearest information accumulating apparatus (server) within a short time, and even at the destination of outing, the printing of the data is effected within a short time.

What is claimed is:

1. A data output system in which a plurality of output apparatuses and a plurality of information accumulating apparatuses are connected together through a network, and data stored in the information storing apparatuses are outputted by the output apparatuses, characterized by the provision of:
pursuing means for pursuing a user's location;
data moving means for moving the data to the information accumulating apparatus corresponding to location information indicative of the user's location; and
output processing means for transmitting the relevant data from the information accumulating apparatus storing the relevant data therein to the output apparatus in accordance with the instructions from the user for the outputting of the data.

2. A data output system according to claim 1, characterized by the provision of:
information display means for displaying the data accumulated in the information accumulating apparatuses on the screen of an information processing apparatus used by the user;
designating means for designating desired data from among the displayed data; and
transmitting means for transmitting the designated data to the information processing apparatus used by the user.

3. A data output system according to claim 1, having user designating means for designating the user, and characterized in that the information of the degree of importance, urgency, etc. is designated in said user designating means.

4. A data output system according to claim 1, characterized in that said pursuing means specifies the user's location on the basis of location information transmitted by an information processing apparatus used by the user.

5. A data output system according to claim 1, characterized in that said moving means selects the information accumulating apparatus corresponding to location information indicative of the user's location, and moves the data to the selected information accumulating apparatus.

6. A data output system according to claim 2, characterized in that said information display means displays the data name of the data moved to the nearest information accumulating apparatus and addressed to the relevant user on the screen of the information processing apparatus used by the user.

7. A data output system according to claim 6, characterized in that said output processing means transmits at least one datum selected from among the displayed data to the output apparatus.

8. A data output system according to claim 1, characterized in that the data is document data, and the output apparatuses are printing apparatuses.

9. A data output system according to claim 1, characterized in that said moving means determines whether the location information has been updated, and selects the information accumulating apparatus corresponding to the location information in conformity with the determination that it has been updated.

10. A data output system according to claim 1, characterized in that said moving means moves the data when the information accumulating apparatus currently storing the data therein and the information accumulating apparatus corresponding to the location information differ from each other.

11. A data outputting method of causing data stored in information accumulating apparatuses to be outputted by output apparatuses in a data output system wherein a plurality of output apparatuses and a plurality of information accumulating apparatuses are connected together through a network, characterized by:
pursuing a user's location;
moving the data to the information accumulating apparatus corresponding to location information indicative of the user's location; and
transmitting the relevant data from the information accumulating apparatus storing the relevant data therein to the output apparatus in accordance with the instructions from the user for the outputting of the data.

12. A data outputting method according to claim 11, characterized by:
displaying the data accumulated in the information accumulating apparatuses on the screen of an information processing apparatus used by the user; and
transmitting data designated from among the displayed data to an information processing apparatus used by the user.

13. A data outputting method according to claim 11, characterized in that the name of the user using the data, and the information of the degree of importance of the data, urgency of the data, etc. can be designated.

14. A data outputting method according to claim 11, characterized in that the user's location is specified on the basis of the location information transmitted by an information processing apparatus used by the user.

15. A data outputting method according to claim 11, characterized in that the information accumulating apparatus corresponding to the location information indicative of the user's location is selected, and the data is moved to the selected information accumulating apparatus.

16. A data outputting method according to claim 12, characterized in that the data name of the data moved to the nearest information accumulating apparatus and addressed to the relevant user is displayed on the screen of the information processing apparatus used by the user.

17. A data outputting method according to claim 16, characterized in that at least one datum selected from among the displayed data is transmitted to the output apparatus.

18. A data outputting method according to claim 11, characterized in that the data is document data, and the output apparatuses are printing apparatuses.

19. A data outputting method according to claim 11, characterized in that whether the location information has been updated is determined, and the information accumulating apparatus corresponding to the location information is selected in conformity with the determination that it has been updated.

20. A data outputting method according to claim 11, characterized in that the data is moved when the information accumulating apparatus currently storing the data therein and the information accumulating apparatus corresponding to the location information differ from each other.

21. An information terminal used by a user in a data output system for moving data to an information accumulating apparatus corresponding to the user's location specified by a location managing apparatus, characterized by the provision of:
transmitting means for transmitting the location of said information user to said location managing apparatus;
display means for displaying on a screen the data moved to said information accumulating apparatus and addressed to the user; and
specifying means for specifying data to be outputted from among the displayed data.

22. An information processing apparatus used by the provider of data in a data output system for moving the data to an information accumulating apparatus corresponding to a user's location specified by a location managing apparatus, characterized by the provision of:
designating means for designating the user; and
transmitting means for transmitting the data to the information accumulating apparatus with the designation of the user.

23. An information accumulating apparatus in a data output system for moving data to an information accumulating apparatus corresponding to a user's location specified by a location managing apparatus, characterized by the provision of:
information storing means storing therein a transmission program for transmitting the data to other information accumulating apparatus corresponding to the user's location, and the data; and
moving means for executing said transmission program, and moving the data to the other information accumulating apparatus corresponding to the user's location.

24. A storage medium storing therein a program executed in a data output system for moving data to an information accumulating apparatus corresponding to a user's location specified by a location managing apparatus, characterized in that said program makes a computer execute;
the step of pursuing the user's location;
the step of moving the data to the information accumulating apparatus corresponding to the user's location; and
the step of transmitting the relevant data from an information accumulating apparatus storing the relevant data therein to an output apparatus in accordance with the instructions from the user for the outputting of the data.

25. A program executed in a data output system for moving data to an information accumulating apparatus corresponding to a user's location specified by a location managing apparatus, characterized by making a computer execute;
the step of pursuing the user's location;
the step of moving the data to the information accumulating apparatus corresponding to the user's location; and
the step of transmitting the relevant data from an information accumulating apparatus storing the relevant data therein to an output apparatus in accordance with the instructions from the user for the outputting of the data.
